(19) United States
(12) Patent Application Publication
(10) Pub. No.: US 2025/0315855 A1
(43) Pub. Date: Oct. 9, 2025

(54) CONTEXT-SPECIFIC ITEM RECOMMENDATION SERVICES INCLUDING CONTEXTUAL OFFER RECOMMENDATION ENGINE

(71) Applicant: Target Brands, Inc., Minneapolis, MN (US)

(72) Inventors: UTSAV MISHRA, Bengaluru (IN); GAURAV BANGAD, Bengaluru (IN); SHARUN S. THAZHACKAL, Bengaluru (IN); MUDIT RANJAN PATI, Bengaluru (IN)

(21) Appl. No.: 19/169,686

(22) Filed: Apr. 3, 2025

Related U.S. Application Data
(60) Provisional application No. 63/573,806, filed on Apr. 3, 2024.

(51) Int. Cl. G06Q 30/0211; G06N 3/092; G06Q 30/0207

(52) U.S. Cl. CPC G06Q 30/0211; G06N 3/092; G06Q 30/0224

(57) ABSTRACT

A system for providing context-specific item recommendations is provided, for example in support of customer loyalty programs. In examples, a contextual offer recommendation engine utilizes a deep neural network in an epsilon-greedy agent to implement a contextual multi-arm bandit. The contextual multi-arm bandit is used to explore optimal solutions regarding correspondence between offers and customers. The optimal solutions may represent customer-offer combinations which may be published to a campaign manager for display to a customer, e.g., via a retail server. The deep neural network may be continually and adaptively retrained an extended based on observed actions between customers and new or preexisting offers.

### CROSS-REFERENCE TO RELATED APPLICATIONS

The present application claims priority from U.S. Provisional Patent Application No. 63/573,806, filed on Apr. 3, 2024, the disclosure of which is hereby incorporated by reference in its entirety.

### BACKGROUND

In a retail environment, a large percentage of items that are sold, in aggregate, are by users who are regular visitors to that retailer, e.g., on a regular or semi-regular basis. To encourage such purchases, a retailer may employ a loyalty program that incentivizes such visitors to make purchases. These incentives may take the form of spending thresholds and cash back, offers for particular items, and the like. However, often it is difficult to determine the appropriate incentive that can be offered to visitors that maximizes the overall effect for individual users.

To better determine which incentives to be applied by a retailer, various data science techniques have been employed, such as collaborative filtering and matrix factorization. However, these approaches have drawbacks. For example, often, such techniques lack adaptability and scalability toward use of new data. In the context of a retail environment having a consistently changing clientele, item collection, and loyalty member group, a requirement to perform refreshed collaborative filtering or matrix factorization techniques on a frequent basis to accommodate those changes may be computationally complex, especially in the context of large retail organization having a significant number of loyalty program members (often in the millions) and eligible products (also in the millions). Accordingly, techniques to improve the flexibility and accuracy of offer recommendations are desired that avoid the significant computational challenges of existing systems.

### SUMMARY

Aspects of the present disclosure are directed to an adaptable, extensible structure for providing context-specific item recommendations, for example in support of customer loyalty programs. In examples, a contextual offer recommendation engine utilizes a deep neural network in an epsilon-greedy agent to implement a contextual multi-arm bandit. The contextual multi-arm bandit is used to explore optimal solutions regarding correspondence between offers and customers. The optimal solutions may represent customer-offer combinations which may be published to a campaign manager for display to a customer, e.g., via a retail server. The deep neural network may be continually and adaptively retrained an extended based on observed actions between customers and new or preexisting offers.

In a particular aspect, a method of generating context-specific incentive offers to users in a retail environment is provided. The method includes constructing an interaction matrix from historical user interactions with incentive offers, and applying a non-negative matrix factorization to the interaction matrix to obtain an approximation of the interaction matrix including dense interaction data, the dense interaction data including user context features and offer features. The method further includes applying a contextual multi-armed bandit across a plurality of users and a plurality of offers to generate, a matrix of expected rewards across the plurality of offers for each of the plurality of users. The contextual multi-armed bandit employs an epsilon-greedy agent implementing a deep learning model to: across a plurality of iterations, select an offer from among the plurality of offers and approximate an expected reward for the offer; and learn from observed rewards generated by an environment to train a deep learning model implemented within the neutral-epsilon agent to approximate an expected reward for each offer. The method further includes, based on the matrix of expected rewards associated with the plurality of users and the plurality of offers, select, for at least some of the plurality of users, one or more offers, and displaying at least one of the one or more offers to the given user.

In a further aspect, a method of generating personalized offer recommendations using a neural network-based contextual multi-armed bandit system is provided. The method includes receiving, at a computing system, customer context features and offer features for a plurality of customers and a plurality of offers in a customer-offer interaction matrix. The method also includes processing the customer context features through a customer network, and processing the offer features through an offer network. The method further includes combining outputs from the customer network and the offer network in a common tower network, and generating, via the common tower network, predicted rewards for each offer for a given customer. The method includes selecting an offer using an epsilon-greedy algorithm, receiving an observed reward based on customer interaction with the selected offer, and updating weights of the customer network, offer network, and common tower network based on the observed reward to improve subsequent offer predictions.

In a still further aspect, a contextual offer recommendation system includes a sparse interaction matrix captured from customer interaction data associated with a plurality of customers and a plurality of offers, wherein the sparse interaction matrix is stored in memory and includes, for each combination of a customer and an offer, a binary representation of whether the customer interacted with the offer. The system further includes a set of customer features and a set of offer features extracted from the sparse interaction matrix by non-negative matrix factorization, and an epsilon-greedy agent including a deep neural network. The epsilon-greedy agent is configured implement a multi-armed bandit approach by: selecting an offer from among the plurality of offers; and predicting, via the deep neural network, an expected reward associated with a customer for the selected offer based on the set of customer features and the set of offer features. The system further includes a publishing service communicatively coupled to a campaign manager and configured to communicate one or more combinations of a customer and a selected offer to the campaign manager to be presented to a customer via a retail server.

### BRIEF DESCRIPTION OF THE DRAWINGS

FIG. 1 illustrates an example environment in which aspects of the present disclosure may be implemented.

FIG. 2 illustrates an example set of possible incentives presented to a loyalty customer in accordance with aspects of the present disclosure.

FIG. 3 illustrates an interaction matrix useable in conjunction with the contextual offer recommendation engine described herein.

FIG. 4 illustrates a high-level architectural flow diagram depicting creation of offer recommendations within a loyalty service, according to an example embodiment.

FIG. 5 illustrates a detailed data flow diagram depicting a loyalty program recommendation engine, according to example embodiments.

FIG. 6 illustrates a high-level schematic of a neutral epsilon agent arrangement, according to an example embodiment.

FIG. 7 illustrates an example agent architecture useable in the data flow diagram of FIG. 6.

FIG. 8 illustrates details of an agent network useable to implement aspects of the contextual offer recommendation engine of the present disclosure.

FIG. 9 illustrates a contextual multi arm bandit structure useable in accordance with the present disclosure to implement an offer recommendation engine.

FIG. 10 illustrates an example experimental setup for testing effectiveness of the contextual offer recommendation engine of the present disclosure.

FIG. 11 illustrates a schematic of an automatic offer allocation process useable within the present disclosure to deploy offers within a retail environment, according to an example embodiment.

FIG. 12 illustrates a detailed architecture diagram of an automatic offer allocation platform useable to deploy offers within a retail environment, according to an example embodiment.

FIG. 13 illustrates an example computing system with which aspects of the present disclosure may be implemented.

### DETAILED DESCRIPTION

As briefly described above, embodiments of the present invention are directed to a system for presenting contextual incentive offers to particular users within an online or mobile application-based retail environment, for redemption either online or in-store.

Specifically, the present disclosure relates to a system for efficient and accurate generation of offer recommendations to be provided to loyalty customers of a retail enterprise. The system integrates a recommendation engine, also referred to herein as a Contextual Offer Recommendation Engine (CORE), used to recommend personalized offers to each loyalty program customer. The system described herein is powered by, among other features, a contextual multi-arm bandit model built on top of a rich custom feature set including transactions, promotions, and customer behavior that optimizes for customer engagement including offer adds and redemption. In example aspects, this recommendation system solves interaction sparsity and deploys a deep neural agent to find highly relevant offers, while remaining adaptable and extensible as loyalty program customers join/exit and as offers evolve and are added or removed. As such, to a visitor to a store or browser of a retail website, it may appear that offers are picked specifically for that user.

In example aspects, the system of the present disclosure is adapted to increase loyalty customer engagement determining optimal offer(s) from a set of thousands of offers for over one hundred million potential loyalty customers. While implemented in some instances specifically for use with loyalty customers in the context of enrollment in a loyalty program it is recognized that similar techniques may be applied to offers and customers outside of a loyalty context.

To address the need for personalization at a customer level more generally, the contextual offer recommendation engine leverages a reinforcement learning algorithm to learn a customer's observed preferences, purchases, and behaviors. The engine then generates highly relevant ranked offers, that significantly increase customer engagement. As described below, the engine's combination of an epsilon-greedy learning algorithm and multi-armed bandit approach enables scalability and flexibility of the overall analysis framework, allowing for adaptation to changes in underlying data quickly and without reconstructing data sets.

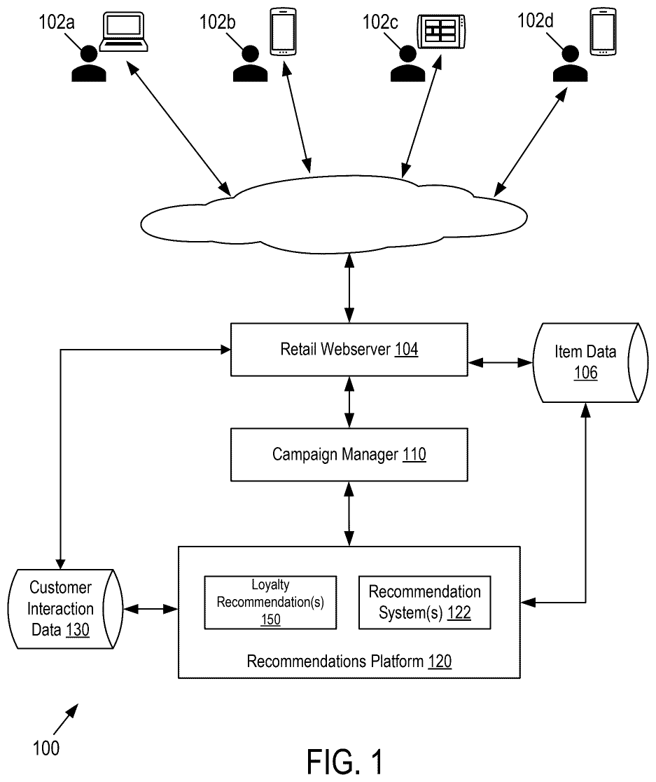

Referring first to FIG. 1, an example environment in which aspects of the present disclosure may be implemented is shown. The environment 100 illustrates a collection of customers 102, shown individually as customers 102a-d. Each of the customers 102 may be a loyalty customer of an enterprise, such as a retail enterprise. Each customer may interact with a retail web server 104, for example as part of a digital shopping service, or to view offers that may be redeemed in-store as part of a store visit and in-store purchasing experience. In this instance, the retail web server 104 may present both a digital shopping experience to a customer 102, and may also present such redeemable offers that may be used either online or in-store (e.g., via scan of a barcode or other redemption technique). As such, the retail Web server 104 may access item data 106 to present item details to the customers 102 for purposes of either online or in-store shopping. The customers 102 may access the retail web server 104 via a variety of types of computing devices, including via either web browser or mobile application.

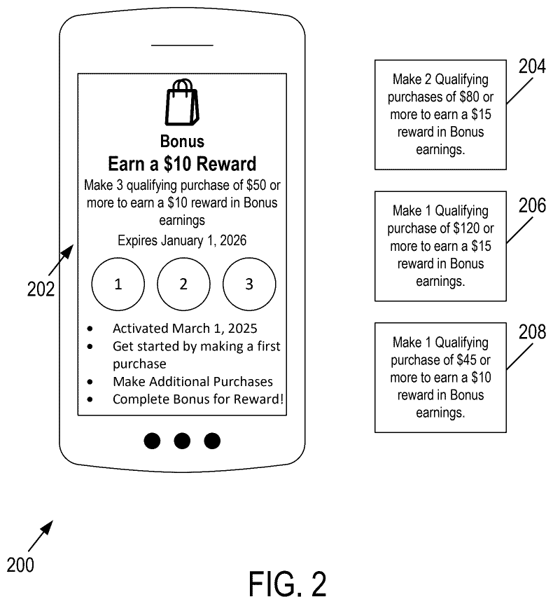

In the example shown, a campaign manager platform 110 may be communicatively connected to the retail web server 104. The campaign manager platform 110 is configured to deliver one or more recommended, or placed, incentives within the user interface presented by the retail web server 104. In some instances, the recommended or placed incentives may include incentives to purchase particular items, such as coupons, discounts, and the like. In other examples, the incentives may include various loyalty incentives, for example providing discounts in response to purchases at particular spending levels, repeat visits or purchases, and the like. An example of some types of loyalty-based incentives are illustrated below in conjunction with FIG. 2.

In the example shown, a recommendations platform 120 includes a loyalty recommendations system 150 as well as one or more other recommendation systems 122. The recommendations platform includes one or more computing systems configured to generate recommendations, for example based on item data 106, as well as customer interaction data 130. The customer interaction data 130 may include browsing history information, purchase information, and other interaction information associated with any one or more of the users 102.

The loyalty recommendations system 150 may be used to identify and deliver to the campaign manager 110 one or more loyalty incentives associated with particular customers, specifically loyalty customers of the retail enterprise. As further discussed below, the loyalty recommendations system 150 may include a contextual offer recommendation system that is quickly adaptable to and configurable to deliver to a particular user an offer that is tailored to that customer's interests and historical interactions with the retail web server 104. In examples, the loyalty recommendations system may integrate a loyalty service that implements a contextual offer recommendation system (CORE) as described herein.

The recommendation systems 122 may be used to deliver various types of other purchase incentives to users, for example including both loyalty and regular customers. For example, the recommendation systems 122 may generate recommendations regarding items to purchase based on past user interactions (e.g., using customer interaction data 130), similarity between past purchased items and items for which incentives exist, and the like.

Referring to FIG. 2, an example user device 200 is shown depicting display of one of a variety of loyalty incentives that may be selected for display to a user, such as a customer 102 of FIG. 1. In this example, the user device 200 presents a user interface including a first available offer that can be presented to a user. For instance, FIG. 2 shows an example offer “Make 3 qualifying purchases of $50 or more to earn a $10 reward in bonus earnings.” This type of offer encourages regular engagement with the retail enterprise, rewarding consistent shopping behavior. However, it may be difficult to determine whether this offer, or another similar offer, may be more encouraging. In the example shown, other offers are presented, such as an first alternative offer 204 of making two qualifying purchases of $80 or more to obtain $15 in bonus earnings, a second alternative offer 206 of making one qualifying purchase of $120 or more to earn a $15 reward, or a third alternative offer 208 of making one qualifying purchase of $45 or more to earn a $10 reward. It may desirable to present to a user an offer that encourages continued interaction, or in some instances marginally increased interaction, so a customer who already would make one purchase within a relevant time period may be presented an offer to incrementally increase a number or purchases, or spending thresholds, or both. However, determining an optimal offer to present to such a customer can be difficult given the ever-changing manner in which customer behavior may change. Still further, “success” in terms of selecting the correct offer may correspond to an offer that the customer selects (or “opts in” to), or may instead correspond to an offer that the customer in fact completes (e.g., obtains the benefits from, for example by completing the requisite purchases).

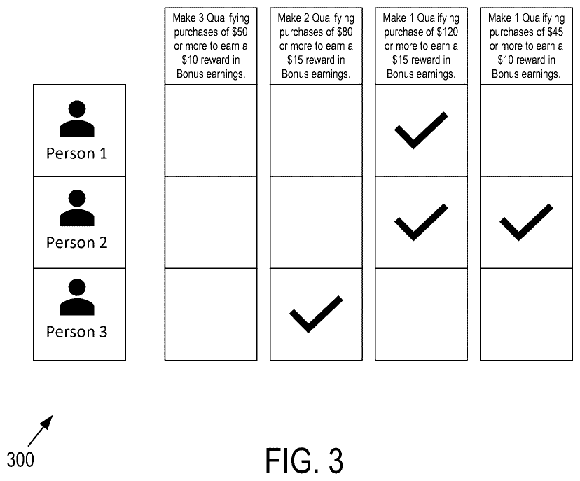

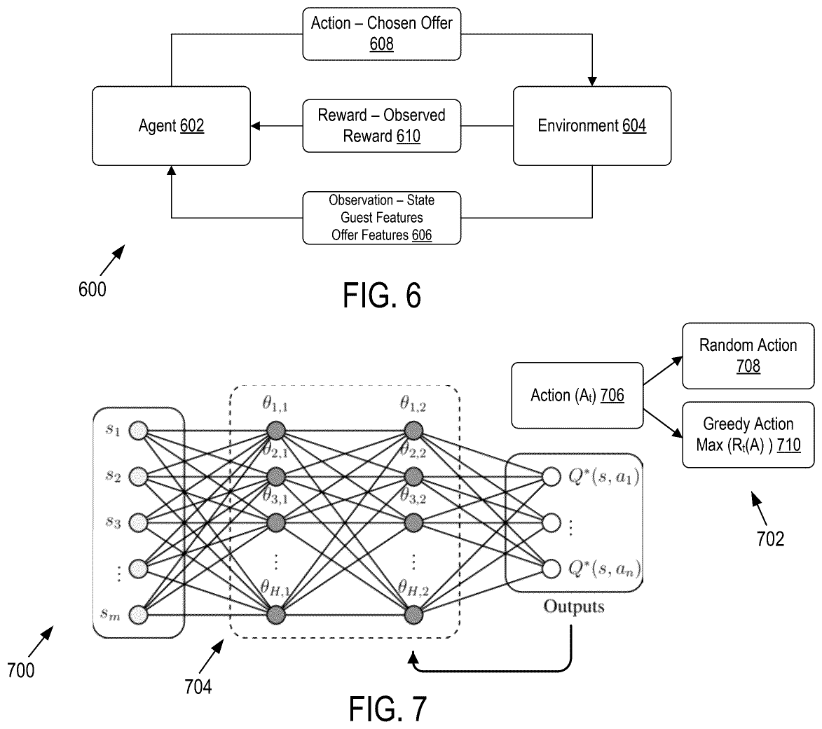

As discussed in further detail below, in example embodiments, a contextual multi-arm bandit (CMAB) algorithm of the present application includes the state of the environment in the decision-making process, allowing context-specific decisions at the time of presentation of an offer to a loyalty customer. The CORE system as discussed herein employs a combination of matrix factorization techniques and a CMAB to generate pertinent offers for efficient delivery to customers. Details regarding this process are provided further below in conjunction with FIGS. 6-9; in the general case, historic customer offer interactions may be used to construct an interaction matrix (e.g., as in FIG. 3). This matrix is highly sparse as individual customers might have only a few interactions with loyalty offers. In the example matrix 300 shown in FIG. 3, it can be seen that the rows show individual customers and the columns reflect offer indices, and the score is binary—either there was interaction between customer and offer, or there was not.

A non-negative factorization approach is used to isolate customer features and offer features, and to improve matrix density. Such factorized features may be used as input to a deep learning model for predicting reward scores. The deep learning model may be implemented within an epsilon-greedy agent, which selects individual arms within a contextual multi-armed bandit workflow. By iterating through various combinations of users and offers, and utilizing a epsilon-greedy agent to assist with reinforcement learning to approximate an expected reward for each action based on current context, an optimal solution of particular customer-offer combinations may be identified, thereby enabling generation of customer-specific offers that are highly tuned to the individual customer. Details regarding each aspect of this disclosure are provided further below in conjunction with FIGS. 6-9.

### System Architecture and Data Flow

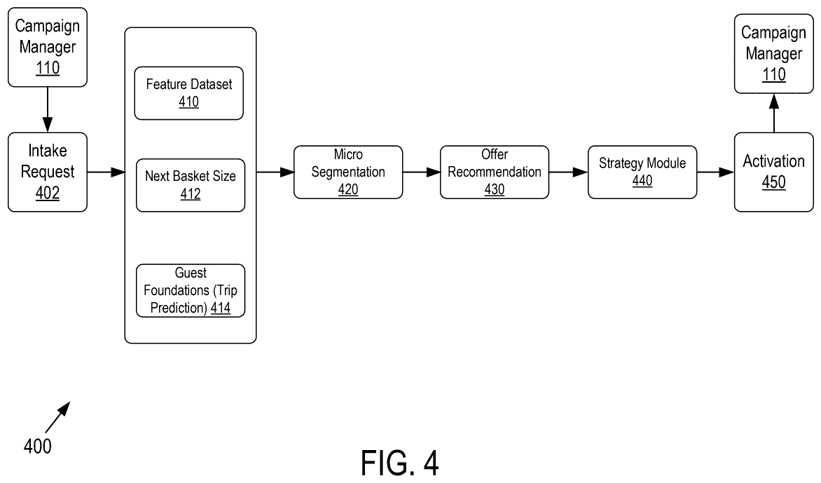

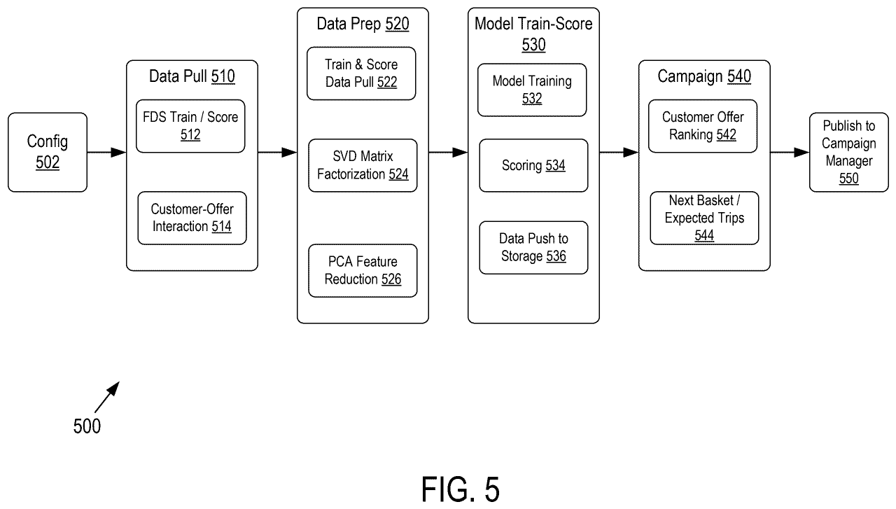

Referring first to FIGS. 4-5, details regarding technological integration of a loyalty recommendations system 150 within the context of a retail enterprise are provided. Specifically, FIGS. 4-5 shown architectural and data flow details of a loyalty service integrated with a campaign manager (e.g., such as campaign manager 110) useable to deliver highly-customizable digital offers to individualized customers for in-person or online use.

FIG. 4 illustrates a high-level architectural flow diagram 400 depicting creation of offer recommendations within a loyalty service, according to an example embodiment. In the example as illustrated, and intake request 402 may be received from a campaign manager 110. The intake request may correspond to, e.g., a request to initiate a loyalty incentive for one or more user populations including loyalty users. The intake request may include, for example, a start date and end date for the proposed loyalty offer, an objective, a budget, and the like.

In the example shown, the intake request 402 may be provided to a modeling component, including a feature data set 410, a next basket size model 412, and a customer foundations model 414. The feature data set 410 retrieves and prepares data relating to historic interactions with customers. The feature data set 410 may include a total or average spend, a total or average basket size, a level of digital engagement, a level of engagement with offers (e.g., interaction or redemption), and the like.

In examples, the feature data set 410 includes an extent of a customer's interactions with one or more offers. In this instance, the retrieval may form a customer-offer interaction matrix, illustrating the extent of each customer's interaction with each offer. Given the large number of customers and offers, such a customer-offer interaction matrix is generally sparsely populated at this stage.

The next basket size model 412 performs a prediction on each customer based on historical information to determine, within a particular time period, a likely size of customer basket that would be part of a purchase (both in terms of number of items and overall spend). The next basket size may be used, for example to establish clusters of customers who may be considered similarly for purposes of offer selection.

The customer foundations model 414 may generate learned features associated with a given customer. Learned features may correspond to latent features associated with a given customer determined from customer interaction data, as compared to directly observable features. The modeled or learned features may include, e.g., redemption probability scores obtained from historical interaction data, enterprise models, such as next basket size and trip calculator models, feature-based calculation, such as historical interactions with offers and previous campaigns used to train redemption scoring models, contextual factors such as digital engagement levels, and the like.

In the example shown, the modeled features, next basket size, and customer trip predictions may be provided to a micro segmentation module 420. The micro segmentation model receives a collection of user identifiers from a forward data service (described below in conjunction with FIG. 5) and segments the collection into smaller groups of customers based on, for example, engagement level, expected basket size, expected number of trips or shopping events within a predetermined period, and the like. In examples, the engagement level may fall within one of a plurality of classified buckets, such as high, medium, and low engagement. Specifically, clusters of users may correspond to groups of customers having a similar engagement level (e.g., high/medium/low engagement), subdivided by expected basket size range and redemption probability score. An audience grid captures expected customer volumes by expected basket size and trip. Table 1, for example, represents a fictitious set of segments of customers based on high engagement, and within various basket sizes and numbers of trips. Similar grids, with each entry representing a segment of users and based on actual modeled data, may be created for low, medium, and high engagement levels.

TABLE 1
High Engagement Grid (Number of Customers)

| Expected | Expected Trips | | | | |
|---|---|---|---|---|---|
| Basket | 0 | 1 | 2 | 3 | 4 |
| 0-30 | 20k | 30k | 40k | 30k | 70k |
| 30-40 | 50k | 70k | 80k | 20k | 10k |
| 40-50 | 30k | 100k | 150k | 200k | 50k |
| 50-60 | 70k | 80k | 90k | 100k | 110k |
| . . . | | | | | |

In the example shown, the segments defined using the micro segmentation module 420 are provided to an offer recommendation service 430. The offer recommendation service 430 may be implemented using a plurality of different offer recommendation systems. One such offer recommendation system useable to generate personalized offer recommendations includes use of the contextual offer recommendation engine (CORE) noted above and described further below, which uses a contextual multi-arm bandit model to generate personalized offer recommendations. The received segments, next basket information, and other customer features may be used as training data for a deep neural network used by the offer recommendation service 430 to perform selections of particular bandit options, as discussed below.

Of course, although the CORE system described below in conjunction with FIGS. 6-9 represents one possible way in which an offer may be identified for use with a user or segment, other types of offers may be provided to audience segments as well, for example based on other campaign goals (e.g., to increase foot traffic in stores, increase basket size, and the like). As such, the strategy module 440 may determine an allocation strategy of specific audience segments to be exposed to offers from across various types of recommended offers, depending on campaign strategy and budget as further discussed below.

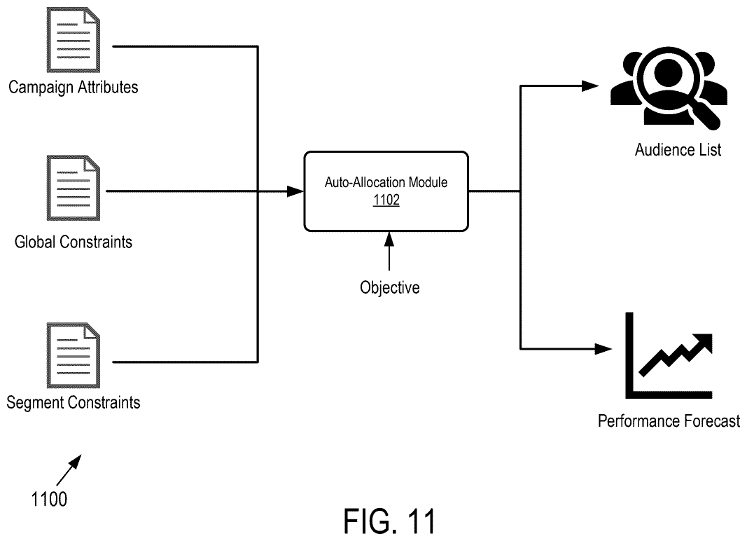

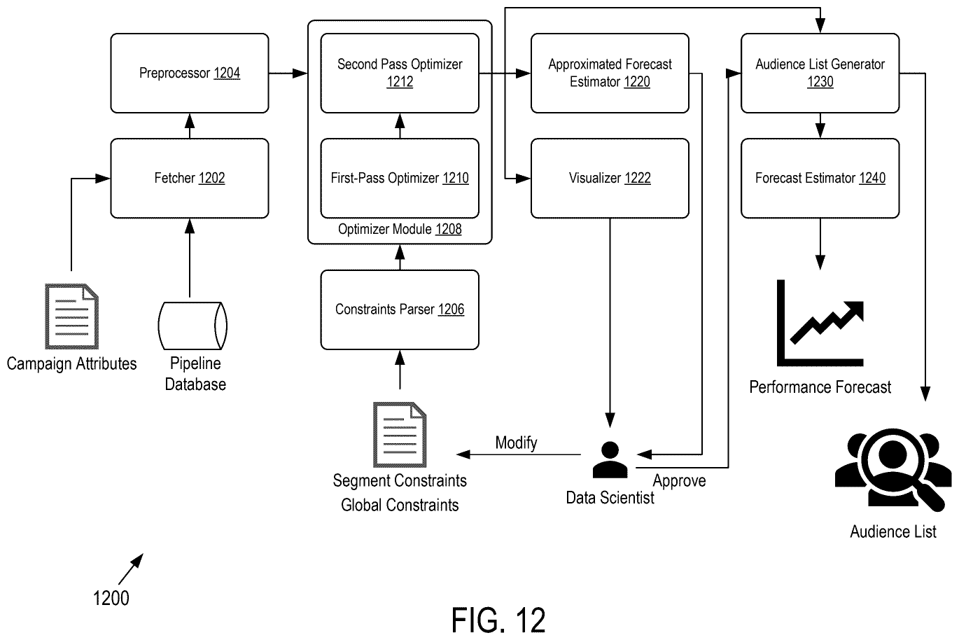

The strategy module 440 may include an opt-in rate calculation as well as an identification of a particular strategy to be used, e.g., the specific segments and offers to be deployed based on the determined offer recommendations. In some instances, the strategy module 440 may be implemented using an automatic allocation process, such as is illustrated below in conjunction with FIGS. 11-12, and involves selecting an audience volume having an expected engagement and reward rate that corresponds to an allowable “budget” for the incentives or rewards to be offered.

In the example shown, the strategy and offers generated by the offer recommendation service 430 and strategy module 440 are activated (at module 450), thereby returning the strategy and specific, selected offers to the campaign manager 110. The strategy module may allocate particular offers to particular customers in accordance with an optimization process based on expected interactions and overall campaign budget. Accordingly, the individual customers, and related strategies for delivery of loyalty offers may be available when the individual loyalty customers visit the retail website (e.g. retail website 104 of FIG. 1) to see their individualized offers, and may be allocated to individuals in accordance with a budget and strategy implemented by the campaign manager 110.

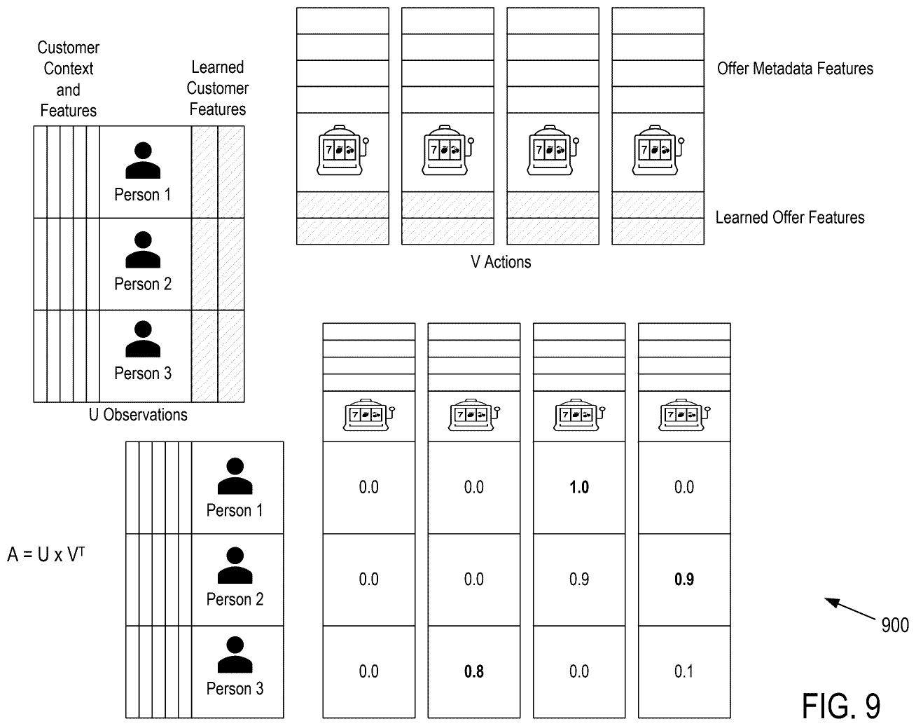

FIG. 5 illustrates a detailed data flow diagram 500 depicting a loyalty program recommendation engine, according to example embodiments. In the example as illustrated, the data flow diagram 500 illustrates that a configuration file 502 is provided to a data pull module 510. The data pull module 510 includes a forward data service training and scoring module 512, as well as a customer offer interaction module 514. The forward data service training and scoring module 512 processes initial data and retrieves, e.g., user profile data and user interaction data for use. The customer-offer interaction module 514 retrieves data from a customer interaction data store, e.g., customer interaction data 130 of FIG. 1. In some cases, as noted above, the customer-offer interaction module 514 may create or obtain a customer-offer interaction matrix; as noted above, prior to use by a contextual multi-armed bandit (CMAB), this matrix may be processed using non-negative matrix factorization (NNMF) to factorize that matrix into a customer matrix and an offer matrix, as noted below. This NNMF technique also exposes learned features (e.g., learned customer features and learned offer features, as shown in FIG. 9) which may be helpful in downstream models.

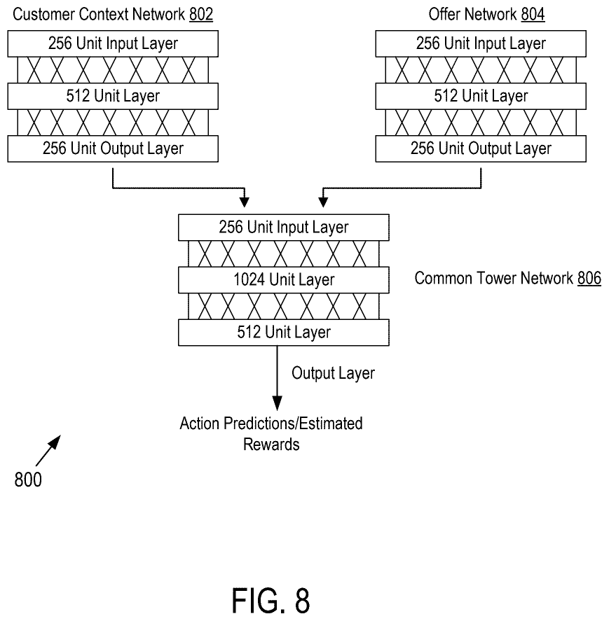

In the example shown, the prepared data may be provided to a model training and scoring service 530. The model training and scoring service 530 includes a model training component 532, a scoring component 534, and a data push process 536, which moves the trained models and scores to storage. The model training component 532 uses the retrieved data to train a deep neural network (e.g., as discussed below in FIGS. 7-8) used in the implementation of the multi-armed bandit arrangement described herein. The scoring component 534 evaluates campaign performance (e.g., implementing the multi-armed bandit based simulations as described herein), while the data push process moves trained models into storage.

In the example shown, a campaign module 540 includes a customer offer ranking module 542 and a next basket predictor 544. The customer offer ranking module 542 generates personalized offer rankings, and the next basket predictor 544 forecasts expected purchase behavior in response to presentation of one or more offers. For example, the next basket predictor 544 may generate predictions for specific customers based on, e.g., customer interaction data 130, and may provide those predictions to the customer offer ranking module 542. The campaign module 540 may then, based on the overall budget for a campaign, select a particular set of customers (or micro-segmented customer groups) and offers for distribution. As in FIG. 4, the data flow diagram 500 depicts that the determined campaigns as generated at the campaign module 540 are published to a campaign manager at module 550 (e.g., published to campaign manager 110 of FIG. 1).

### Contextual Offer Recommendation Engine Architecture and Operation

Now referring to FIGS. 6-9, additional details regarding the contextual offer recommendation engine (CORE) that is incorporated into the loyalty recommendations system 150 of FIG. 1 are provided. The contextual offer recommendation engine involves use of an agent model that interacts with an environment (e.g., a solution space) to determine optimal combinations of customers and offers, thereby optimizing offers for a given customer. In general, CORE involves use of a neutral epsilon greedy agent arrangement (in FIGS. 6-8) to drive selections of “arms” of a contextual multi-arm bandit (CMAB) for purposes of simulating reward outcomes (e.g., in FIG. 9); those reward outcomes may be provided back to the agent in the agent model for retraining. The epsilon greedy approach taken by the agent enables identification of and focus on local maximum returns while exploring the overall solution space by the agent; this allows the agent to continually identify optimal solutions as trends change and as offers may be adjusted, added, or removed. A scoring matrix may be generated based on the predicted reward outcomes as well, representing a prediction of the extent of correspondence between customers and offers. Based on a combination of the customer and offer matches, customer next basket size, and overall campaign spend, selected customer-offer combinations may be deployed to a campaign manager for use.

### Neutral-Epsilon Agent

FIG. 6 illustrates a high-level schematic of a neutral epsilon agent arrangement 600, according to an example embodiment. The arrangement 600 includes an agent 602, interacting with an environment 604. In the example shown, the environment 604 provides an observation 606 as to the current state, customer features, and offer features. For example, an observation may correspond to simulated presentation of a set of offers to a user. The agent 602, implementing a deep neural network, generates a selection of an offer based, for example, on expected returns with respect to the offers considered. The agent 602 returns the chosen offer 608 to the environment 604. The environment 604 then performs a scoring process as to the selection returned by the agent 602, and calculates an observed reward 610 that is then returned to the agent 602. The observed reward is then stored and also used for retraining of the agent (e.g., in conjunction with the expected reward determined by the agent 602 for the selected offer). For example, a difference between the observed reward and expected reward may be considered a loss function, and a training process performed with an objective of minimizing the loss function (e.g., optimizing the ability of the deep neural network to accurately predict an expected reward based on selection of a given offer by a particular customer).

Through repeated operation by the agent 602 and environment 604, an agent may act as a hypothetical customer, thereby simulating a selection of an offer represented within the environment 604. As noted above, the selection of the offer, and comparison of expected reward to actual or observed reward may enable the agent 602 to be retrained, and adjust its selection criteria (e.g. using a greedy algorithm as described below) for subsequent instances of offer selection as part of the multi-armed bandit-based solution approach. Through use of a series of selections and retraining processes, expected rewards for a variety of offers across a large collection of users may be generated, thereby enabling prediction of highly performing offers for specific users or user groups.

FIG. 7 illustrates an example of an epsilon-greedy agent 700, according to an example embodiment. Such an epsilon-greedy agent 700 is a type of reinforcement learning agent that combines an epsilon-greedy algorithm 702 with a deep neural network (DNN) 704. The deep neural network 704 is used to approximate the expected reward for each action, based on the current context (e.g., the details of the customer and of the offer being considered), thereby allowing the agent to select from either, e.g., an expected optimal action or a random action for exploration (the tradeoff among these being described further below). One of the benefits of the epsilon-greedy algorithm is that it is simple to implement and easy to tune.

As illustrated, the epsilon-greedy algorithm 702 includes a determined action 706, which may correspond to a random action 708 or a greedy action 710. As actions 706 are selected from among the random and greedy actions, outputs are generated from the DNN 704, and the output may be fed back to the DNN for further training to tune the weights of various nodes within the DNN 704. The selection of a greedy action 710 rather than a random action enables tuning toward or in an area of solutions where an expected reward is high, while maintaining a number of random actions 708 enables broad exploration and coverage over the solution space of possible reward outcomes across all available offers.

FIG. 8 illustrates a particular example DNN 800, useable as the deep neural network 704 of FIG. 7. The DNN 800 includes a customer network 802, an offer network 804, and a common tower network 806. The customer network 802 handles the processing of the customer or context features, e.g., including obtained and learned customer features. In the example shown, the customer network has three layers, a 256 unit input layer, a 512 unit mid layer, and a 256 unit output layer. The output of the customer network 802 is fed into the common tower network 806. Generally speaking, the customer network is trained on customer features, and takes as the observation information 606 of FIG. 6.

The offer network 804, as shown, processes features specific to each offer. In the example shown, the offer network similarly includes three layers, a 256 unit input layer, a 512 unit mid layer, and a 256 unit output layer. The output of the offer network 804 is also fed into the common tower network 806. Generally speaking, the offer network 804 receives offer parameter information as input information, including both obtained and learned offer parameter information, from among the observation information 606 of FIG. 6.

The common tower network 806 combines the information from networks 802, 804 and processes it through three additional layers; in the example shown, a 256 unit input layer, a 1024 unit middle layer, and a 512 unit final output layer. The final output layer outputs, for example, an action prediction and/or estimated reward given the received customer context and offer parameter information. The action prediction or estimated reward may be used by the agent to make action selections (e.g., the chosen offer 608) associated with the multi-armed bandit arrangement described herein. Based on the actual observed reward (e.g., the reward 610 of FIG. 6), the deep neural network 800 may be retrained to better identify maximum rewards in future predictions (and resultant arm selections).

In a particular example implementation, the customer network 802 and offer network 804 process their respective features in parallel. These networks feed their outputs into the common tower network 806, which combines the information to predict actions and estimate rewards. The epsilon-greedy algorithm then uses these predictions in two ways. With probability epsilon (e.g., 0.05), it selects a random action (exploration). With probability 1−epsilon, it selects the action with the highest predicted reward from the DNN output (exploitation). The DNN 800 learns from observed rewards generated by the environment, with rewards computed based on approximate interactions in a matrix I. When a customer opts in, the reward is +1; otherwise, it is −0.1. This creates a feedback loop where the DNN 800 provides reward estimates for each potential offer, and the epsilon-greedy algorithm uses these estimates to balance exploration/exploitation. The resulting interactions generate new training data, and the DNN updates weights to improve future predictions. The overall system maintains a predetermined (e.g., 5%) randomness (epsilon=0.05) while using the DNN's predictions of highest estimated reward for the remaining 95% of decisions, allowing it to both exploit learned patterns and continue exploring new offer combinations.

In this context, an optimal action may correspond to an action that maximizes expected reward values. A regret factor may be calculated as lost potential reward by comparing the expected reward of the optimal action with that of the action actually taken. In some instances, a sub-optimal arms metric may be calculated as a sum of instances or time steps in which the optimal arm was not selected.

Additionally, in some instances, for purposes of retraining, rather than simply retraining on existing data, other samples out of a prediction set may be used, and new offers can be introduced using individual users or micro-segments of users. The epsilon-greedy approach may eventually integrate such new offers and user segments as needed; in further implementations, an agent may utilize further algorithms such as an upper confidence bound (UCB) to ensure an at least minimal exploration rate to enable exploration of new solution space (new offers and/or new users).

### Contextual Multi-Armed Bandit Structure

FIG. 9 illustrates a contextual multi arm bandit (CMAB) structure 900 useable in accordance with the present disclosure to implement an offer recommendation engine. The CMAB structure 900 may be implemented as an “environment” on which an agent (e.g., agent 602) acts to compute expected rewards and thereby generate scores for customer-offer combinations. CMAB excels in environments where the reward distributions of actions are not known a priori and must be estimated from observed outcomes. The process as described herein iteratively refines these estimates, maximizing the expected reward as the agent is trained through iterative processes. That is, the CMAB structure 900 leverages contextual customer information compared to standard multi-arm bandit to ultimately provide more accurate recommendations.

As illustrated, each “arm” selected as part of a multi arm bandit process corresponds to one of the offers (e.g., in the vertical columns). Each offer is associated with a set of metadata describing offer features, as well as subsequently “learned” offer features (e.g., latent features of the offer as obtained through Non-Negative Matrix Factorization, discussed below). Similarly, each customer, or person, has a set of customer context features (from user interaction data 130) and learned customer features, and the agent selection performed as described above in conjunction with FIGS. 6-8 corresponds to a selection by a particular person, as the deep learning model uses a particular user ID and customer context (represented as observations U). The offer features are described in metadata, and represent actions V. The customer observations U and actions V are extracted from a customer-offer interaction matrix generated from customer interactions, for example also achieved using the non-negative matrix factorization process described below. A scoring process utilizes the agent which, based on context, will select a particular arm (either randomly or optimally according to the epsilon-greedy approach), and combine the observations U and actions V for a customer-offer combination (e.g., by taking an inner product of corresponding rows of U and V corresponding to the selected customer and offer) to predict a reward generated for that customer in response to selection of that arm/offer. Iterative selection of various arms/offers, generation of expected rewards, and error minimization between observed rewards and expected rewards, may enable training of the CMAB to generate a score for each customer for each individual bandit arm (e.g., each offer).

Stated differently, in each round of execution of the multi-armed bandit, an agent (e.g., agent 602, 700) may select an offer from among the number of offers, or arms, based on contextual customer information obtained for a particular customer. A result of selection of the arm is a prediction of a reward, corresponding to predicted outcomes of selection of the arm. During a training phase, actual rewards may be compared to these predictions (e.g., using historical data) and the difference between these, corresponding to a loss function, is observed. The agent (and related DNN) may be retrained to minimize this loss function to improve prediction capabilities. Through repeated simulation of customer behaviors in selecting particular arms, or offers, and seeing the resulting rewards, a solution may be generated representing a matrix of customers and offers, with scores representing expected rewards. This matrix may be used to select one or more offers for a user or users that results in maximized cumulative rewards in the long run based on context and experience.

In a formalized statement, given an input of context Cₜ at time t, and an action set A, output an action aₜ at time t:

$$max E [ {\sum }_{t = 1}^{T} {R}_{t} ( {a}_{t} ) ]$$

where T is a total number of interactions, Rₜ(aₜ) is a reward received aₜ time t for the action aₜ, and E[ ] represents the expectation.

An example advantage of this arrangement is that the model used to perform simulations using the multi-armed bandit is only required to learn one reward function, whose input is both the customer features U and the offer features V for the selected customer/offer included in the execution iteration. In this way, the multi-armed bandit approach enables use of an unlimited number of offers, while allowing for easy extension to new offers that may be desired to be added and analyzed.

### Reward Scalarization for Multi-Objective Optimization

The above discussion of a CMAB and related optimization problem relates generally to a process of optimization by minimizing a loss function that represents a difference between expected and observed reward, given a particular offer selection. In multi-objective optimization, all reward signals may be combined into a single scalar value, thereby allowing the analogous bandit algorithm to be applied when multiple objectives are involved.

In a particular implementation, a hypervolume corresponding to a set of two or more objectives may be scalarized according to the following equation:

$${R}_{t} ( {a}_{t} ) = 〈 w , {r}_{t} ( {a}_{t} ) 〉$$

In this instance, Rₜ(aₜ) is a scalarized reward aₜ time t for action aₜ. w is a weight vector representing importance of each objective, sampled from a unit sphere. That is, Rₜ(aₜ) is a vector of rewards for action aₜ aₜ time t.

This scalarization transforms the multi-objective problem into a single objective problem by converting a vector of rewards into a single, scalar reward. By sampling a weight W appropriately, the optimization process may be made to explore tradeoffs between different objectives (e.g., maximizing interactivity, maximizing return, or the like).

In some instances, a hypervolume scalarization process may be used to enable optimization over multiple objectives to be transformed into maximizing scalarized reward over the action space for randomly sampled weight vectors w. This enables the expected scalarized reward to be directly related to the hypervolume indicator, which promotes convergence. Furthermore, hypervolume scalarization provides improved solution finding in convex and non-convex regions, which makes such scalarization methos more versatile than linear scalarization methods. It is noted that in some instances, however, linear scalarization or Chebyshev scalarization may be used as well or instead of hypervolume scalarization.

In the context of the CMAB above, the hypervolume scalarization may be incorporated by randomly sampling weight vectors and computing a scalarized reward for each action, with the agent policy being to select the action that maximizes the scalarized reward:

$${a}_{t} = arg max {R}_{t} ( a ) = arg max 〈 w , {r}_{t} ( a ) 〉$$

By repeating this process over a number of iterations with different sampled weights w, the agent similarly explores various regions of the objective solution space, and also balances exploration and exploitation, but across multiple objectives.

The scalarization of multiple objectives has a number of advantages in this context. For example, the same advantages of extensibility and balanced exploration are achieved. Further, additional computational efficiency is obtained, since multiple objectives are accounted for without significant increase in computational complexity, but instead extending the single-objective approach described above.

### Non-Negative Factorization

Non-Negative Matrix Factorization (NNMF) is used in the CMAB structure of FIG. 9 to reduce sparsity in interactions when ingesting customer interaction data (e.g., data 130). This is used because of its proficiency in uncovering latent features that represent underlying customer preferences and offer attributes (e.g., learned customer features and learned offer features). This method is particularly beneficial as it can capture the nonlinear relations in the data, thereby providing a deeper insight into user-offer interactions.

In example implementations, NNMF is applied to factorize the customer-offer matrix into matrices W (user matrix) and H (offer matrix).

The factorization can be represented as follows:

$$V \approx W \times {H}^{T}$$

Where V is the original interaction matrix, W is the user matrix, and Hi is the offer matrix, and H^{T}i is the transpose of the offer matrix.

In subsequent steps, the offer latent features (H) will be leveraged as bandit's per-arm features in the CMAB approach, aiding in the fine-tuning of personalized offer recommendations.

The reverse computation can be carried out to find an approximate interaction matrix I′ using the factorized matrices as:

$${I}^{′} = W \times {H}^{T}$$

This I′ is the approximation of the original interaction matrix, which retains most of the significant information from the original matrix. As such, as described above, each offer becomes a single arm bandit and customer features become context.

Aided by the dense interaction data I,′ the neural network used herein for arm selection provides a stable environment where the loss function aptly gauges the divergence between predicted and actual values. This not only guards against overfitting but also improves the model's accuracy over successive iterations.

### Maximizing Efficacy in Recommendations

Referring to FIGS. 6-9 generally, to maximize efficacy in recommendations, it may be important, in uncertain environments, to explore different options to gain more information. The contextual multi-arm bandit (CMAB) used in the CORE system described herein incorporates an exploration mechanism, which helps in discovering the effectiveness of various offers despite limited information. In particular, exploration delves into testing different offers to uncover what truly resonates with customers for long term gain. Exploration may be achieved through the agent's selection of random actions (e.g., random actions 708) to explore otherwise unvisited solution space. In contrast, exploitation focuses on presenting customers with offers that are most likely to engage them in the short term—e.g., by selecting a greedy action 710 based on feedback regarding maximum rewards received in response when a particular arm of the CMAB is selected (e.g., making selections in a vicinity of a maximum observed reward 610 returned to the agent 602).

It is noted that, in accordance with the present disclosure, the feedback gained from exploration is particularly useful in refining future offer recommendations. By balancing a tradeoff between exploration and exploitation, the CORE system is able to learn from dynamic customer preferences as preferences change and as offers vary, allowing for automated alignment with evolving market trends and extensible offer additions to the system. It is noted that this balancing of the explore and exploit tradeoff is similar to balancing a bias vs. variance tradeoff. High levels of exploration might result in less-than-optimal offers in the short term, whereas a low exploration rate can create an echo effect, where the recommendation model becomes restricted to its previous predictions for future learning.

As illustrated, the CMAB structure 900 is adept at handling scenarios with inherent uncertainties, where outcomes of actions are unknown. Due to the sparse nature of customer-offer interaction data, the algorithm employs risk-reward balancing techniques, enhancing decision accuracy as it gathers more data and reduces uncertainty. In example implementations tying the CMAB structure 900 back to the agent environment used to select arms as illustrated in FIGS. 6-8, the environment 604 may provide contextual customer information and offer metadata, allowing the algorithm to make informed decisions. The reward estimation output from the agent (e.g., from the deep neural network 704) allows the agent to learn from observed rewards (e.g., observations 610) generated by the environment. Rewards are computed based on approximate Interaction in matrix I.′ The agent 602 interacts with the environment 604, selecting offers based on state information and predicted rewards. It employs the Neural Epsilon-Agent approach to balance exploration and exploitation. Accordingly, at the agent 602, a deep network is developed to approximate the expected reward for each offer.

The epsilon-greedy algorithm implemented by the agent 602 works by selecting actions in one of two ways. With a probability epsilon, the agent 602 will select a random action (exploration). With a probability 1−epsilon, the agent 602 will select the action that has the highest expected reward (exploitation). Epsilon is a hyper-parameter that determines the balance between exploration and exploitation. A high value for epsilon will result in more exploration, while a low value will result in more exploitation. Referring back to the example seen in FIG. 9, resultant scores from combinations of customers and arms (offers) results in a scoring matrix showing simulated reward values. Reward values above a predetermined threshold (or a top X number of reward values per customer or arm) may be selected for use and published downstream (e.g., made eligible for distribution to customers via the campaign manager).

### Test Results

As generally noted above, the loyalty offer incentives described herein have an objective of increasing interactivity, and have a secondary objective of enabling reward actions to be completed. As such, to determine performance of such a system, an “opt in” rate represents a primary metric of success (i.e., increased interactivity), while incremental sales may represent a secondary or derived metric.

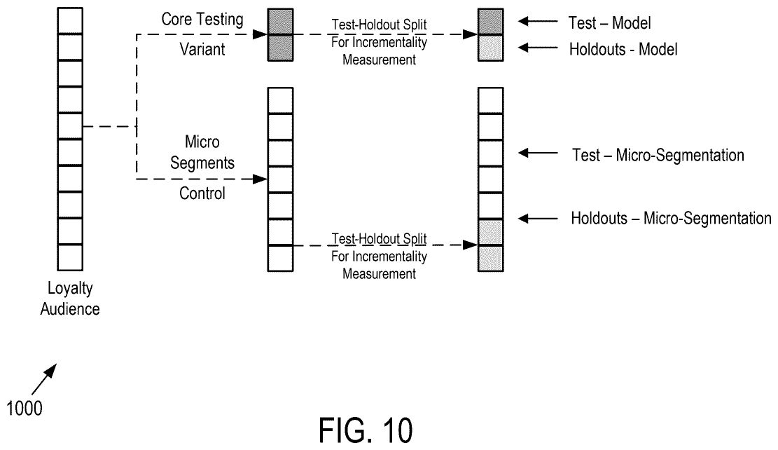

FIG. 10 illustrates an example experimental setup for testing effectiveness of the contextual offer recommendation engine of the present disclosure. In particular, an example test traffic allocation 1000 is illustrated in FIG. 10, and which is useable to implement and monitor loyalty recommendations in accordance with the present disclosure. The test traffic allocation 1000 may be used to control traffic to which contextual recommendations are made, for example to maintain monitoring of the efficacy of the model through selective distribution of such offers to portions of an eligible population. As illustrated, an A/B experimentation framework is provided built on a multi-variate stratified sampling method. Specifically, in the example as illustrated, an audience of loyalty customers is split into two groups: a variant group (receiving offers according to the contextual offer recommendation systems described herein) and a control group (using a baseline, general-purpose modeling methodology).

In addition, a hold out group is kept separate from both variant and control for incremental sales measurement. The primary metric of interest, as noted above, is the opt-in rate, i.e., the percentage of customers who opted in or added the offer divided by total number of customers who received the offer. The secondary metric here is the completion rate, defined as the percentage of customers who completed the offer from the initial pool of customers who opt-ed in.

In experimental scenarios, seven tests with the contextual offer recommendations were performed, and improvements in user engagement were seen across engagement metrics in each test. Overall, the primary metric for this testing, opt-in, % saw a statistically significant lift of +28% while the secondary success metric (completion rate) observed a statistically significant 70% lift. The variant in the testing enabled more customers to engage with content on the retail website and mobile application, as well as in physical retail locations.

Key findings show that CORE-recommended offers generated a statistically significant lift in engagement across customer engagement segments. This has been tested across seven months, where recommendations were scaled from 15% into 100% of customers in successive months for seven-day, 21-day and 30-day offer validity periods. To scale the recommendation processes for handling all customer offers, a streamlined data preparation and model deployment process was used (e.g., as described above in conjunction with FIGS. 4-5).

### Automatic Offer Allocation and Deployment

Referring now to FIGS. 11-12, an example automatic offer allocation process and platform are illustrated. The automatic offer allocation processes provided may be implemented, for example, as part of the strategy module 440 and/or activation 450 of FIG. 4, for purposes of optimizing allocation of offer distributions to customers while maximizing the expected return on the expense of such an offer or incentive program. The offer allocation process and platform may be implemented, for example, within a recommendations platform 120, such as seen in FIG. 1.

In general, the present disclosure enables determination of an optimal offer allocation to maximize incremental sales, promotional sales, or number of trips by a customer, given offer segments, a set markdown or incentive budget, and other constraints. The automatic offer allocation process provides significant improvements in terms of reduction of manual time required to establish audiences and filtering of such audiences, as well as removes some limits on previous flexibility in strategy planning and audience definition.

FIG. 11 illustrates a schematic of an automatic offer allocation process 1100 useable within the present disclosure to deploy offers within a retail environment, according to an example embodiment. The offer allocation process as illustrated provides a set of campaign attributes, global constraints, and segment constraints to an auto-allocation module 1102. The auto-allocation module 1102 will receive an objective to be maximized, and in response, will generate an audience list (e.g., a list of customer identifiers or an audience identifier that can be used for a given offer or incentive program) as well as a performance forecast illustrating the expected performance of the given offer or incentive, based on the objective, constraints, and selected audience.

FIG. 12 illustrates a more detailed architecture diagram of an automatic offer allocation platform 1200 useable to deploy offers within a retail environment, according to an example embodiment. The automatic offer allocation platform 1200 may be used, for example, in the context of any of a variety of types of offers, including the loyalty offers as described herein.

In the example shown, the automatic offer allocation platform 1200 fetches audience and campaign data at a fetcher 1202, and provides this information to a preprocessor 1205 which constructs clusters of potential audience members (e.g., customers) based on predicted basket sizes and redemption sores of individual customers. Based on those clusters, the preprocessor may also computer cluster-specific statistics, such as expected promotional sales, redemptions, deliveries, markdown, and the like.

A constraints parser 1206 receives, for example, segment constraints and global constraints to be applied to the campaign. The constraints may include, for example, a maximum or minimum markdown spend, a maximum basket stretch allowed, a minimum number of offer deliveries, a maximum number of offer deliveries, and the like. These constraints may be set at a campaign-wide level or for a particular offer and segment.

An optimizer module 1208 includes a first pass optimizer 1210 and a second pass optimizer. The first pass optimizer 1210 performs an optimization process without minimum constraints, and creates an initial allocation based solely on maximizing input objectives (e.g., maximizing revenue, increasing engagement, and the like). The first pass optimizer 1210 also avoids “overflow” of offer allocations to customers above threshold values.

The second pass optimizer 1212 runs an optimization process on unallocated clusters to satisfy campaign and offer-level minimum constraints. The second pass optimizer ensures proper distribution across customer segments, and maintains expected basket size ranges for different offer types. Because a first pass performed by the first pass optimizer 1210 may not follow the inherent characteristics of offer allocations (e.g., it may allocate offers to high basket-size customers without covering a spectrum of customers), the second pass using constraints on unallocated clusters provides a balance of optimized execution (in a first pass) and allocation across cluster types (covered by the second pass).

After the second pass optimizer 1212, an output optimization solution, in the form of an allocation matrix, is provided to an approximated forecast estimator, which generates a segment-wise forecast of performance of the particular campaign. The allocation matrix is further provide to a visualizer 1222, which allows viewing of the allocation matrix by a data scientist prior to deployment/publication. This allows for human in the loop correction by allowing that individual to modify one or more segment constraints or global constraints and rerun one or both of the optimization processes.

In the example shown, the allocation matrix is also provided to an audience list generator 1230, which collects a list of user identifiers to be used with the clusters selected and identified in the allocation matrix. This audience information is output as an audience list, and is provided to a forecast estimator 1240 which may be used to output a performance forecast as noted above.

A mathematical representation of the optimization process is provided below:
m→number of guest clusters
i=1, 2, . . . , m→indices corresponding to the guest clusters
red_probᵢ→average redemption probability for guest cluster i
pred_bsᵢ→average basket size for guest cluster i
countᵢ→number of guests in cluster i
n→number of offer segments. Each offer segment consists of a threshold and discount value
j=1, 2, . . . , n→ indices corresponding to available offer segments
tᵢ→threshold value for offer segment j. This will be 0 for percentage offers and a positive value for threshold offers
dᵢ→Discount given for offer segment j. This will be a percentage value for percentage offers and in absolute dollars for threshold offers
stretchᵢⱼ→average basket stretch for cluster i if they're given offer j; for threshold offers,
stretchᵢⱼ=tⱼ−dⱼ−pred_bsᵢ; for percentage offers, stretchᵢⱼ=−pred_bsᵢ*(dⱼ/100)
min_spendᵢⱼ→Minimum average amount cluster i would spend if allocated with offer j, and is equivalent to max(pred_bs_i, tj)
Mₘᵢₙ, Mₘₐₓ→Minimum and maximum markdown budgets for the campaign
Dₘᵢₙ, Dₘₐₓ→Minimum and maximum deliveries for the campaign
Dₘᵢₙ, Dₘₐₓ→Minimum and maximum deliveries for the campaign
Sₘₐₓ→maximum stretch allowed per guest for the campaign
min_markdownⱼ, max_markdownⱼ→minimum and maximum markdowns for offer segment j
min_deliveriesⱼ, max_deliverieⱼ→minimum and maximum deliveries for offer segment j
min_red_probⱼ→minimum redemption probability for offer segment j
min_bsⱼ→minimum basket size requirement for offer segment j
fⱼ→Safeness score for offer segment j. It is a regulating parameter to minimize the risk. Higher the discount, lower the safeness score is. Only used for drive trips & promo sales
cᵢⱼ→convince factor for offer segment j estimating how lucrative/convincing the discount is. Used only for incremental sales
eᵢⱼ→A binary flag indicating eligibility of cluster i for offer segment j, and is set to 1 if the stretch is below Smax. Used only for incremental sales
xᵢⱼ→Binary decision variable indicating allocation of offer segment j to cluster i

A goal of the optimization process is to maximize a particular objective (e.g., incremental sales, according to a particular goal, subject to constraints. Specifically, the maximization process is to find a maximum of:

$${\sum }_{i = 1}^{m} {\sum }_{j = 1}^{n} {exp\_stretch}_{i j} * {c}_{i j} * {e}_{i j} * {x}_{i j}$$

Which is subject to the following constraints and conditions:

$$\begin{matrix}{\sum }_{j = 1}^{n \text{?}} \text{?} {x}_{ij} \leq 1 & ∀ cluster i , \\ {\sum }_{i = 1}^{m} {\sum }_{j = 1}^{n} {exp\_markdown}_{ij} * \text{?} {x}_{ij} ∈ [ {M}_{min} , {M}_{max} ] , & \\ {\sum }_{i = 1}^{m} {\sum }_{j = 1}^{n} {count}_{i} * \text{?} {x}_{ij} ∈ [ {D}_{min} , {D}_{max} ] , & \\ {\sum }_{i = 1}^{m} {count}_{i} * \text{?} {x}_{ij} ∈ [ {min\_deliveries}_{j} , {max\_deliveries}_{j} ] & ∀ offer segment j \\ {\sum }_{i = 1}^{m} {exp\_markdown}_{ij} * \text{?} {x}_{ij} ∈ [ {min\_markdown}_{j} , {max\_markdown}_{j} ] & ∀ offer segment j \\ {\sum }_{i = 1}^{m} {exp\_redeemers}_{ij} * \text{?} {x}_{ij} \geq min\_red {\_prob}_{j} , * {\sum }_{i = 1}^{m} ( {count}_{i} * \text{?} {x}_{ij} ) & ∀ offer segment j \\ {\sum }_{i = 1}^{m} {min\_spend}_{ij} * {count}_{i} * \text{?} {x}_{ij} \geq {\sum }_{i = 1}^{m} {min\_bs}_{j} * {count}_{i} * \text{?} {x}_{ij} & ∀ offer segment j\end{matrix}$$

$${exp\_stretch}_{ij} = {red\_prob}_{i \text{?}} * {stretch}_{ij} ,$$

$${exp\_markdown}_{ij} = {red\_prob}_{i \text{?}} * {d}_{j} ,$$

$${exp\_redeemers}_{ij} = {red\_prob}_{i} * {count}_{i} ,$$

$${c}_{ij} = 1 / log ( max ( {exp\_stretch}_{ij} , 0 ) + e ) ,$$

$$ε {\text{?}}_{ij} = 1 if {exp\_stretch}_{ij} \leq {S}_{max} else 0 ,$$

$$\text{?} \text{indicates text missing or illegible when filed}$$

In alternative implementations, maximization of other objectives, such as drive trips, or promotional sales, may be similarly defined:

### Drive Trip Maximization:

$${\sum }_{i = 1}^{m} {\sum }_{j = 1}^{n} {stretch}_{i j} * {exp}_{r} {edeemers}_{i j} * {f}_{j} * {b}_{i} * {x}_{i j}$$

### Drive Trip Constraints:

$${exp\_redeemers}_{ij} = {red\_prob}_{i} * {count}_{i} ,$$

### Promotional Sales Objective Maximization:

$${\sum }_{i = 1}^{m} {\sum }_{j = 1}^{n} exp\_promo {\_sales}_{i j} * {f}_{j} * {b}_{i} * {x}_{i j}$$

Promotional sales Constraints:

$$exp\_promo {\_sales}_{i j} = {\sum }_{i = 1}^{m} {min\_spend}_{ij} * {count}_{i} * {red\_prob}_{i} for offer segment j ,$$

In some implementations, a safeness score is used, which represents a parameter used to ensure that no offer segment is overpopulated, and that the proportions of segment customers in an audience list is inversely proportional to discount amounts. Accordingly, the higher the discount, the higher the risk associated with a given offer segment. As such, an audience count is generally kept to a comparatively lower number for higher-discounted offer segments.

### Example Computing Environment

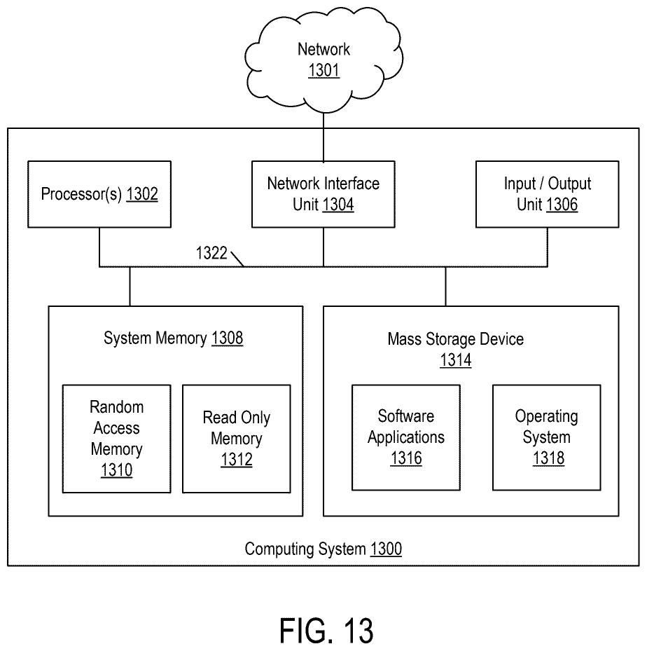

FIG. 13 illustrates an example block diagram of a virtual or physical computing system 100. One or more aspects of the computing system 1300 can be used to implement the processes described herein.

In the embodiment shown, the computing system 1300 includes one or more processors 1302, a system memory 1308, and a system bus 1322 that couples the system memory 1308 to the one or more processors 1302. The system memory 1308 includes RAM (Random Access Memory) 1310 and ROM (Read-Only Memory) 1312. A basic input/output system that contains the basic routines that help to transfer information between elements within the computing system 1300, such as during startup, is stored in the ROM 1312. The computing system 1300 further includes a mass storage device 1314. The mass storage device 1314 is able to store software instructions and data. The one or more processors 1302 can be one or more central processing units or other processors.

The mass storage device 1314 is connected to the one or more processors 1302 through a mass storage controller (not shown) connected to the system bus 1322. The mass storage device 1314 and its associated computer-readable data storage media provide non-volatile, non-transitory storage for the computing system 1300. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable, and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1300.

According to various embodiments of the invention, the computing system 1300 may operate in a networked environment using logical connections to remote network devices through the network 1301. The network 1301 is a computer network, such as an enterprise intranet and/or the Internet. The network 1301 can include a LAN, a Wide Area Network (WAN), the Internet, wireless transmission mediums, wired transmission mediums, other networks, and combinations thereof. The computing system 1300 may connect to the network 1301 through a network interface unit 1304 connected to the system bus 1322. It should be appreciated that the network interface unit 1304 may also be utilized to connect to other types of networks and remote computing systems. The computing system 1300 also includes an input/output controller 1306 for receiving and processing input from a number of other devices, including a touch user interface display screen, or another type of input device. Similarly, the input/output controller 1306 may provide output to a touch user interface display screen or other type of output device.

As mentioned briefly above, the mass storage device 1314 and the RAM 1110 of the computing system 1100 can store software instructions and data. The software instructions include an operating system 1118 suitable for controlling the operation of the computing system 1100. The mass storage device 1114 and/or the RAM 1110 also store software instructions, that when executed by the one or more processors 1102, cause one or more of the systems, devices, or components described herein to provide functionality described herein. For example, the mass storage device 1314 and/or the RAM 1310 can store software instructions that, when executed by the one or more processors 1302, cause the computing system 1300 to receive and execute managing network access control and build system processes.

The disclosed computing system provides a physical environment with which aspects of the system described herein may be implemented. It is noted that the disclosure computing system may be used to implement an incentive or recommendation computing system, a retail website server, one or more cloud servers used to provide associated services, database servers storing item information, or end-user devices, such as a personal computing system having a browser installed thereon, or a mobile device having either a browser or mobile application installed therein.

Referring to this disclosure overall, this work extends upon efforts to provide personalization at a cohort level to a state of hyper-personalization at a customer level. The current implementation also allows for enhancements to bring multi-objective models, where many metrics can be optimized at once.

According to further example embodiments, the recommendation system of the present disclosure, and in particular the implementation of simplified reinforcement learning described herein paves the way for use of other sequential models, which are contemplated in the present disclosure While bandits optimize for a “next best offer” scenario, sequential models in the future have the potential to find successive order of offers journeys to bring more positive experiences for all users of such a loyalty incentive program.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of recommendation systems, technologies disclosed herein are applicable to data and methods for determining display of items aₜ a retail website generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A method of generating context-specific incentive offers to users in a retail environment, the method comprising:
constructing an interaction matrix from historical user interactions with incentive offers;
applying a non-negative matrix factorization to the interaction matrix to obtain an approximation of the interaction matrix including dense interaction data, the dense interaction data including user context features and offer features;
applying a contextual multi-armed bandit across a plurality of users and a plurality of offers to generate, a matrix of expected rewards across the plurality of offers for each of the plurality of users,
wherein the contextual multi-armed bandit employs an epsilon-greedy agent implementing a deep learning model to:
across a plurality of iterations, select an offer from among the plurality of offers and approximate an expected reward for the offer; and
learn from observed rewards generated by an environment to train a deep learning model implemented within the neutral-epsilon agent to approximate an expected reward for each offer;
based on the matrix of expected rewards associated with the plurality of users and the plurality of offers, select, for at least some of the plurality of users, one or more offers; and
displaying at least one of the one or more offers to the given user.

2. The method of claim 1, wherein the deep learning agent includes a customer network that handles processing of customer context features and an offer network processing offer features specific to each offer of the plurality of offers.

3. The method of claim 2, wherein the deep learning agent further includes a common tower network combining information from the customer network and the offer network to approximate an expected reward based on the customer context features and offer features.

4. The method of claim 1, further comprising receiving user interaction data with the at least one of the one or more offers as part of a subsequent set of historical interactions with one or more incentive offers.

5. The method of claim 1, wherein the user features include at least one of: historical basket size, digital engagement level, and offer interaction history.

6. The method of claim 1, further comprising updating weights within the deep learning model to improve subsequent approximations of expected rewards.

7. The method of claim 6, wherein updating the weights utilizes a loss function representing a difference between the expected reward for the offer and an observed reward for the offer.

8. The method of claim 1, wherein the expected reward corresponds to a scalarized reward value representative of reward values from a plurality of objectives.

9. The method of claim 8, wherein the scalarized reward value is obtained from a hypervolume scalarization process.

10. The method of claim 1, wherein the plurality of offers includes a plurality of loyalty offers.

11. The method of claim 10, wherein the interaction matrix comprises a sparse matrix of customers and offers and includes, for each combination of a customer and an offer, a binary representation of whether the customer interacted with the offer.

12. The method of claim 1, further comprising adding one or more offers to the plurality of offers, and wherein after the one or more offers are added, the contextual multi-armed bandit explores the one or more offers via the epsilon-greedy agent.

13. A method of generating personalized offer recommendations using a neural network-based contextual multi-armed bandit system, the method comprising:
receiving, at a computing system, customer context features and offer features for a plurality of customers and a plurality of offers in a customer-offer interaction matrix;
processing the customer context features through a customer network;
processing the offer features through an offer network;
combining outputs from the customer network and the offer network in a common tower network;
generating, via the common tower network, predicted rewards for each offer for a given customer;
selecting an offer using an epsilon-greedy algorithm;
receiving an observed reward based on customer interaction with the selected offer;
updating weights of the customer network, offer network, and common tower network based on the observed reward to improve subsequent offer predictions.

14. The method of claim 13, further comprising factorizing the customer-offer interaction matrix using non-negative matrix factorization to generate learned customer features and learned offer features.

15. The method of claim 13, wherein the epsilon-greedy algorithm includes:
with probability epsilon, selecting a random offer from the plurality of offers, and
with probability (1−epsilon), selecting an offer having a highest predicted reward from the common tower network.

16. The method of claim 13, wherein:
a positive reward value is assigned when the customer opts in to the selected offer, and
a negative reward value is assigned when the customer does not opt in to the selected offer.

17. The method of claim 13, further comprising selecting one or more combinations of a customer and a selected offer for publication to a campaign manager to be presented to a customer via a retail server.

18. A contextual offer recommendation system comprising:
a sparse interaction matrix captured from customer interaction data associated with a plurality of customers and a plurality of offers, wherein the sparse interaction matrix is stored in memory and includes, for each combination of a customer and an offer, a binary representation of whether the customer interacted with the offer;
a set of customer features and a set of offer features extracted from the sparse interaction matrix by non-negative matrix factorization;
an epsilon-greedy agent including a deep neural network, wherein the epsilon-greedy agent is configured implement a multi-armed bandit approach by:
selecting an offer from among the plurality of offers;
predicting, via the deep neural network, an expected reward associated with a customer for the selected offer based on the set of customer features and the set of offer features;
a publishing service communicatively coupled to a campaign manager and configured to communicate one or more combinations of a customer and a selected offer to the campaign manager to be presented to a customer via a retail server.

19. The contextual offer recommendation system of claim 18, wherein the deep neural network includes a customer network configured to receive customer features, an offer network configured to receive and process offer features, and a common tower network receiving output from the customer network and the offer network and output the expected reward.

20. The contextual offer recommendation system of claim 18, wherein the deep neural network is retrained using a loss function corresponding to a difference between an observed reward and the expected reward predicted by the deep neural network.
